(19) United States
(12) Patent Application Publication
(10) Pub. No.: US 2024/0377982 A1
(43) Pub. Date: Nov. 14, 2024

(54) MULTI-PORT COMMUNICATION OF MEMORY DEVICES FOR VEHICLE MANAGEMENT SYSTEMS

(71) Applicant: Micron Technology, Inc., Boise, ID (US)

(72) Inventor: Minjian Wu, Shanghai (CN)

(21) Appl. No.: 18/660,089

(22) Filed: May 9, 2024

Related U.S. Application Data
(60) Provisional application No. 63/501,779, filed on May 12, 2023.

(51) Int. Cl. G06F 3/06; B60R 16/023; B60R 16/033

(52) U.S. Cl. CPC G06F 3/0655; B60R 16/0231; B60R 16/033; G06F 3/0604; G06F 3/0679

(57) ABSTRACT

Exemplary methods, apparatuses, and systems include a communication port manager for controlling communication of sensor data. The communication port manager receives a set of sensor data from a plurality of data sensors of a vehicle management system of a vehicle. The communication port manager writes the set of sensor data to memory of the memory subsystem. The communication port manager receives, from a battery management system, a request to read the sensor data. The communication port manager sends the set of sensor data to the battery management system, wherein the battery management system uses a wireless connection to send the sensor data to a cloud system.

### CROSS-REFERENCE TO RELATED APPLICATION

The present application claims the benefit of U.S. Provisional Patent Application No. 63/501,779, filed on May 12, 2023, which is hereby incorporated by reference.

### TECHNICAL FIELD

The present disclosure generally relates to multi-port memory devices in memory subsystems, and more specifically, relates to multi-port communication using a shared memory for vehicle management systems.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method of using multiple ports to communicate sensor data of the memory subsystem in accordance with some embodiments of the present disclosure.

FIG. 3 is a flow diagram of an example method of controlling a shared memory for communication of sensor data in accordance with some embodiments of the present disclosure.

FIG. 4 is a block diagram of an example computer system in which embodiments of the present disclosure may operate.

### DETAILED DESCRIPTION

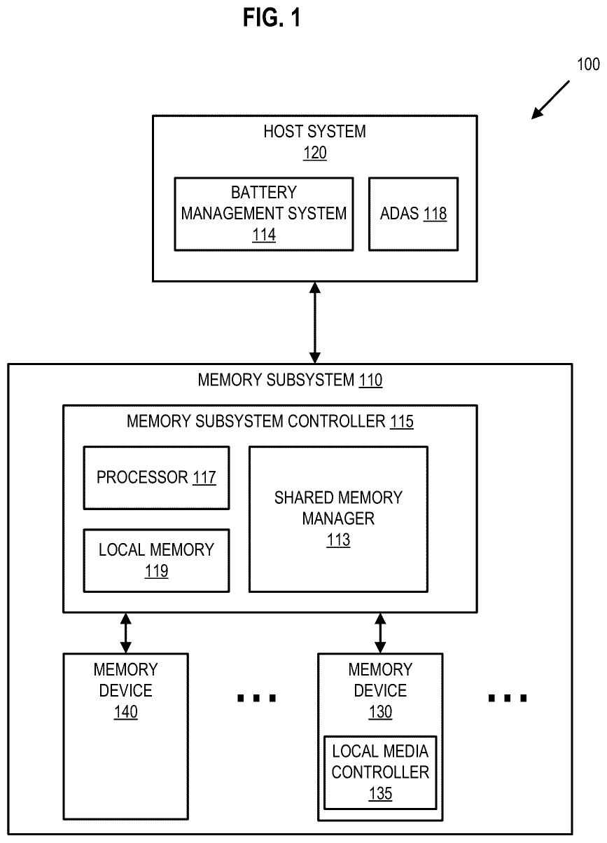

Aspects of the present disclosure are directed to multiport communication between vehicle management systems and shared memory within a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and octo-level cells (OLC). For example, an SLC can store one bit of information and has two logic states.

Operating environments for automotive technology systems increasingly generate large amounts of data. To process such large amounts of data, much of the information is uploaded to a cloud server. In typical systems, a memory subsystem is removable while the vehicle is parked and the memory subsystem can be connected via a wired interface to transfer data to a cloud server. This technique, however, is inefficient and unreliable as the additional time to disconnect and reconnect the memory subsystem requires specific expertise in automotive devices. In other systems, the memory subsystem is coupled to a cellular data network. For example, the memory subsystem uses a fourth generation (4G) or fifth generation (5G) cellular communication network to transfer the data. This technique is limited by cellular network signal strength/connectivity and costs of data transfer using cellular network prohibits scalability. Additionally, some automotive systems that benefit from transferring data to a cloud server are powered off or lack connectivity when the vehicle is parked/turned off, further limiting the ability to transfer data.

Aspects of the present disclosure address the above and other deficiencies by managing a shared portion of memory for the memory subsystem. The shared portion of memory is coupled to different memory subsystems of the vehicle management system such as a data recording system, an advanced driver assistance system (ADAS), and/or a battery management system. The battery management system is connected to a wireless network connection, such as WiFi, even when the vehicle is off. Leveraging the shared portion of memory and using multiple communication ports, the battery management system accesses and transfers data from other subsystems (e.g., subsystems, such as ADAS, that are powered off or otherwise lack connectivity when the vehicle is parked/turned off) to the cloud system. As a result, the data is efficiently accessed and transferred to the cloud system.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

The memory subsystem 110 includes a shared memory manager 113 that configures multiple communication ports for the memory device 130. For example, the shared memory manager 113 configures the first port of the memory device 130 for writing sensor data to available memory. The shared memory manager 113 configures a second port for sending data from the memory device to another memory subsystem. By configuring multiple ports of the memory device 130, the shared memory manager 113 provides a coupling to other subsystems, such as a battery management system 114 or ADAS 118 in addition to the port for receiving write operations. The ADAS 118 is a vehicle subsystem that provides notifications, or interactive inputs to drivers relating to driving and parking tasks. A human-machine interface enables the ADAS to increase safety of operations of the vehicle. The battery management system 114 is connected to a wireless network connection such as WiFi even if the vehicle is off when other memory subsystems are disconnected from wireless communication devices. The battery management system 114 accesses and transfers data from other subsystems (e.g., subsystems that are powered off or otherwise lack connectivity when the vehicle is parked/turned off) to the cloud system.

In some embodiments, the first port for writing sensor data and the additional port connected to the battery management system 114 are different physical communication hardware. The set of sensor data is received by the shared memory manager 113 from a data system of the vehicle management system such as ADAS 118 that records sensor data during operation of the vehicle. In other embodiments, the first port for writing sensor data and the additional port connected to the battery management system 114 is implemented with different communication channels on the same physical hardware.

Shared memory manager 113 can receive sensor data files from the host system 120 or directly from various sensors during powered-on operation of vehicle. In some embodiments, shared memory manager 113 and the host system 120 communicate using a wireless communication protocol within the vehicle management system. The shared memory manager 113 manages access to the set of sensor data such that the memory locations where the set of sensor data is stored to provide access for writing data (e.g., from a driver assistance system) by the communication port manager and reading data by the battery management system 114. To manage the access, the shared memory manager 113 controls a position of a download pointer and an upload pointer which represents locations in memory where sensor data has been written (e.g., download pointer) and where sensor data has been read and sent to the cloud system (e.g., upload pointer). After writing sets of sensor data to memory in a shared namespace, the shared memory manager 113 updates the download pointer. After sending sets of sensor data to the cloud system, the shared memory manager 113 updates the upload pointer.

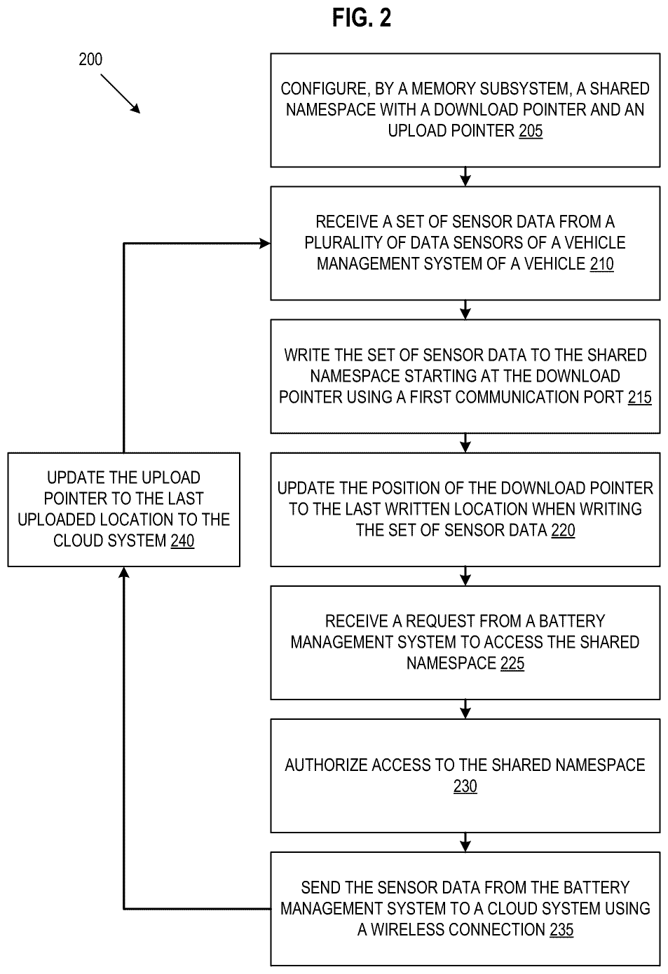

FIG. 2 is a flow diagram of an example method of using multiple ports to communicate sensor data of the memory subsystem in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by shared memory manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the shared memory manager 113 configures a shared namespace with a download pointer and an upload pointer. To configure the shared namespace, the shared memory manager 113 allocates a portion of memory to be accessible for the battery management system 114 and other subsystems, such as the ADAS 118. The shared memory manager 113 assigns the download pointer to the first location in memory that represents a last written location of bits that are written to the shared namespace. The shared memory manager 113 assigns the upload pointer to a second location in memory that represents a last location in memory that has been uploaded to the cloud. For example, the memory locations between the location of the download pointer and the location of the upload pointer represent data bits written to the shared namespace but awaiting upload to the cloud system. If the location represented by the upload pointer is the same location represented by the download pointer, then all data written to the portion of memory has been uploaded to the cloud system. While the example above describes the shared portion of memory as a shared namespace, the shared memory can be any type of memory accessible by multiple subsystems of the vehicle management system.

At operation 210, the shared memory manager 113 receives a set of sensor data from multiple data sensors of a vehicle management system for a vehicle. For example, the shared memory manager 113 is communicatively coupled to the host system 120 and receives data bits from various sensors such as parking sensors, radar, or other sensors of the ADAS 118. The shared memory manager 113 receives the set of sensor data during normal powered operation of the vehicle (e.g., the vehicle is providing power to nominal operating systems of the vehicle). In some embodiments, the set of sensor data is received by the shared memory manager 113 using wireless or wired connections to the various sensors of the vehicle management system.

At operation 215, the shared memory manager 113 writes the set of sensor data to the shared namespace starting at the download pointer using a first communication port. For example, the shared memory manager 113 writes data bits representing the set of sensor data to locations in memory that start at the download pointer.

At operation 220, the shared memory manager 113 updates the position of the download pointer to the last written location when writing the set of sensor data. After writing the set of sensor data at operation 215, the shared memory manager 113 reassigns the download pointer to the last location of memory that is written at operation 215. The difference between the position of the download pointer and the position of the upload pointer represents data that has been written to memory but not yet uploaded to the cloud system.

At operation 225, the shared memory manager 113 receives a request from a battery management system 114 to access the shared namespace. For example, the vehicle management system may power off systems such as memory subsystems that communicate using the first communication port of the memory device 130 while preserving powered on conditions for other memory subsystems such as the battery management system. The shared memory manager 113 receives the request to read the shared namespace between the upload pointer and the download pointer.

At operation 230, the shared memory manager 113 authorizes access to the shared namespace. In response to receiving the request from the battery management system 114, the shared memory manager 113 provides access to the shared namespace for the battery management system 114 to read the set of sensor data from the shared namespace. After receiving access to the shared namespace, the battery management system reads data from the shared namespace. In some embodiments, the shared memory manager 113 provides the memory locations between the download pointer and the upload pointer to facilitate the battery management system 114 sending the set of sensor data to the cloud system.

At operation 235, the shared memory manager 113 sends the sensor data from the battery management system 114 to a cloud system using a wireless connection. For example, the battery management system 114 connects to the cloud system and transfers the set of sensor data to the cloud system using the wireless connection. In some embodiments, the battery management system 114 is receiving power to send the sensor data while other memory subsystems are in a powered off state.

At operation 240, the shared memory manager 113 updates the upload pointer to the last uploaded location to the cloud system. After sending the set of sensor data at operation 235, the shared memory manager 113 reassigns the upload pointer to the last location of memory that is read from the shared namespace at operations 225 and 230 and sent to the cloud system at operation 235. The change in position of the upload pointer represents sensor data that has been uploaded to the cloud system. At the conclusion of operation 240, the method 200 returns to operation 210.

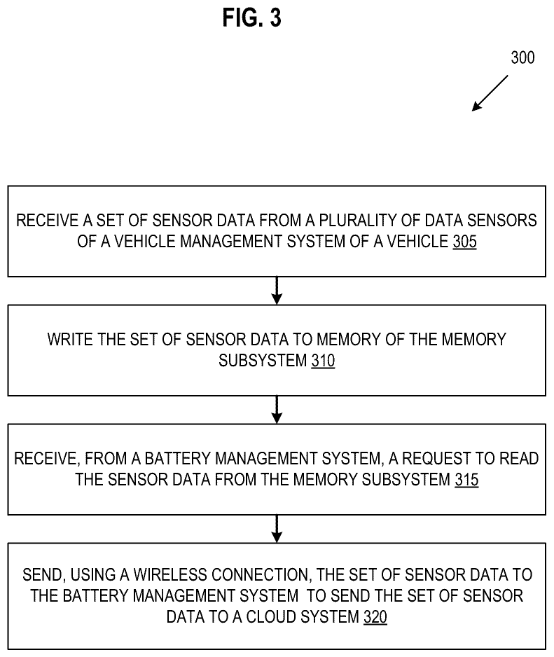

FIG. 3 is a flow diagram of an example method of controlling a shared memory space for communication of sensor data in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by shared memory manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, shared memory manager 113 receives a set of sensor data from multiple data sensors of a vehicle management system of a vehicle. As described above at operation 210, the shared memory manager 113 is communicatively coupled to a network interface device that receives communication from the host system.

At operation 310, the shared memory manager 113 writes the set of sensor data to memory of the memory subsystem. As described above at operation 215, the shared memory manager 113 writes data bits representing the set of sensor data to locations in memory that start at the download pointer.

At operation 315, the shared memory manager 113 receives a request to read the sensor data from the memory subsystem from the battery management system 114. As described above at operations 225 and 230, the shared memory manager 113 receives and authorizes a request to access sensor data by the battery management system 114. After receiving access to the sensor data, the battery management system 114 reads the set of sensor data from the shared portion of memory.

At operation 320, the shared memory manager 113 sends the set of sensor data to the battery management system 114 that uses a wireless connection to send the sensor data to a cloud system. As described above at operation 235, the shared memory manager 113 uses the battery management system 114 to transfer the set of sensor data in the shared portion of memory to the cloud system.

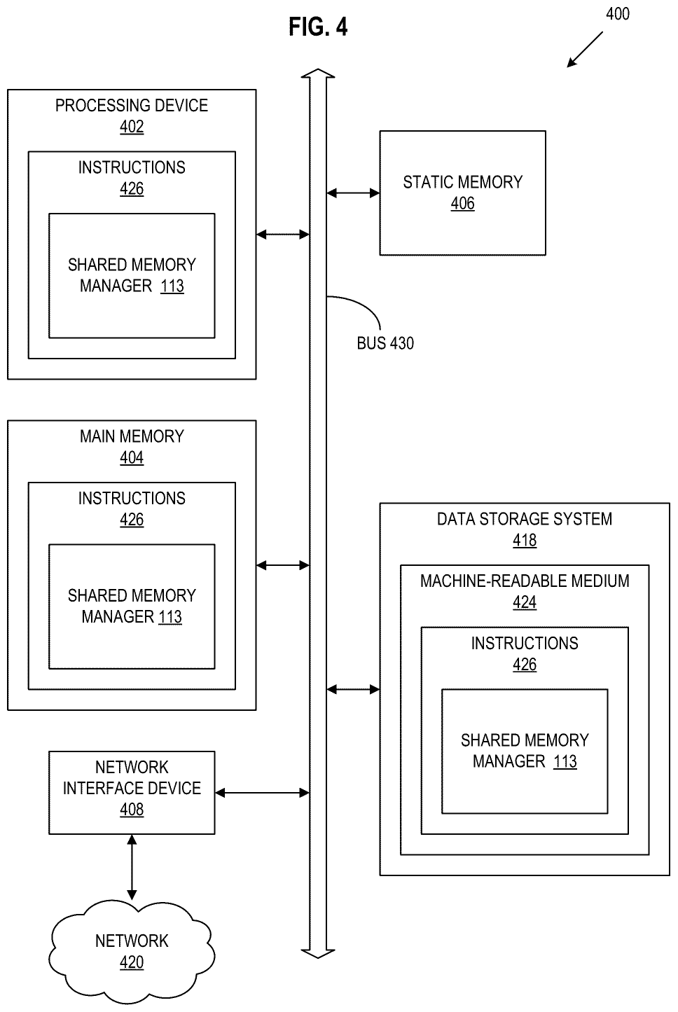

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to shared memory manager 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random-access memory (DRAM) such as synchronous DRAM (SDRAM) or Rambus DRAM (RDRAM), etc.), a static memory 406 (e.g., flash memory, static random-access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory subsystem 110 of FIG. 1.

In one embodiment, the instructions 426 include instructions to implement functionality corresponding to a wireless update performance manager (e.g., shared memory manager 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 200 and 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, by a memory subsystem, a set of sensor data from a plurality of data sensors of a vehicle management system of a vehicle;
writing the set of sensor data to memory of the memory subsystem;
receiving, from a battery management system, a request to read the set of sensor data from the memory subsystem; and
sending the set of sensor data to the battery management system, wherein the battery management system uses a wireless connection to send the set of sensor data to a cloud system.

2. The method of claim 1 wherein receiving, from a battery management system, the request to read the set of sensor data from the memory subsystem comprises the battery management system requesting access to sensor data of a driver assistance system of the vehicle management system that is separate from the battery management system.

3. The method of claim 1, wherein writing the set of sensor data to memory of the memory subsystem comprises:
writing the set of sensor data to a shared namespace of the memory subsystem, wherein the shared namespace is accessible by the battery management system and the vehicle management system.

4. The method of claim 3, wherein writing the set of sensor data to the shared namespace of the memory subsystem comprises:
assigning a download pointer that represents a last written location in the shared namespace where the set of sensor data is written; and
assigning an upload pointer that represents a last uploaded location in the shared namespace that has been uploaded to the cloud system.

5. The method of claim 4, wherein sending the set of sensor data to a cloud system comprises:
transmitting, using the wireless connection and by the battery management system, a portion of the set of sensor data, wherein during transmitting, the vehicle management system is powered off.

6. The method of claim 5, further comprising:
updating the download pointer in response to receiving additional sets of sensor data; and
updating the upload pointer in response to transmitting the portion of the set of sensor data.

7. The method of claim 1, wherein writing the set of sensor data to memory of the memory subsystem is performed using a first port, and wherein receiving, from the battery management system, the request to read the set of sensor data from the memory subsystem is performed using a second port that is different than the first port.

8. A non-transitory computer-readable storage medium comprising instructions that, when executed by a processing device, cause the processing device to:
receive, by a memory subsystem, a set of sensor data from a plurality of data sensors of a vehicle management system of a vehicle;
write the set of sensor data to memory of the memory subsystem;
receive, from a battery management system, a request to read the set of sensor data from the memory subsystem; and
send the set of sensor data to the battery management system, wherein the battery management system uses a wireless connection to send the set of sensor data to a cloud system.

9. The non-transitory computer-readable storage medium of claim 8 wherein to receive, from a battery management system, the request to read the set of sensor data from the memory subsystem, the processing device is caused to receive a request from the battery management system requesting access to the set of sensor data of a driver assistance system of the vehicle management system that is separate from the battery management system.

10. The non-transitory computer-readable storage medium of claim 8, wherein to write the set of sensor data to memory of the memory subsystem, the processing device is caused to write the set of sensor data to a shared namespace of the memory subsystem, wherein the shared namespace is accessible by the battery management system and the vehicle management system.

11. The non-transitory computer-readable storage medium of claim 10, wherein to write the set of sensor data to the shared namespace of the memory subsystem the processing device is caused to:
assign a download pointer that represents a last written location in the shared namespace where the set of sensor data is written; and
assign an upload pointer that represents a last uploaded location in the shared namespace that has been uploaded to the cloud system.

12. The non-transitory computer-readable storage medium of claim 11, wherein to send the set of sensor data to a cloud system the processing device is caused to transmit, using the wireless connection and by the battery management system, a portion of the set of sensor data, wherein during transmitting, the vehicle management system is powered off.

13. The non-transitory computer-readable storage medium of claim 12, the processing device further caused to:
update the download pointer in response to receiving additional sets of sensor data; and
update the upload pointer in response to transmitting the portion of the set of sensor data.

14. The non-transitory computer-readable storage medium of claim 8, wherein writing the set of sensor data to memory of the memory subsystem is performed using a first port, and wherein receiving, from the battery management system, the request to read the set of sensor data from the memory subsystem is performed using a second port that is different than the first port.

15. A system comprising:
a plurality of memory devices; and
a processing device, operatively coupled with the plurality of memory devices, to:
receive, by a memory subsystem, a set of sensor data from a plurality of data sensors of a vehicle management system of a vehicle;
write the set of sensor data to memory of the memory subsystem;
receive, from a battery management system, a request to read the set of sensor data from the memory subsystem; and
send the set of sensor data to the battery management system, wherein the battery management system uses a wireless connection to send the set of sensor data to a cloud system.

16. The system of claim 15 wherein to receive, from a battery management system, the request to read the set of sensor data from the memory subsystem, the processing device is caused to receive a request from the battery management system requesting access to sensor data of a driver assistance system of the vehicle management system that is separate from the battery management system.

17. The system of claim 15, wherein to write the set of sensor data to memory of the memory subsystem, the processing device is caused to write the set of sensor data to a shared namespace of the memory subsystem, wherein the shared namespace is accessible by the battery management system and the vehicle management system.

18. The system of claim 17, wherein to write the set of sensor data to the shared namespace of the memory subsystem the processing device is caused to:
assign a download pointer that represents a last written location in the shared namespace where the set of sensor data is written; and
assign an upload pointer that represents a last uploaded location in the shared namespace that has been uploaded to the cloud system.

19. The system of claim 18, wherein to send the set of sensor data to a cloud system the processing device is caused to transmit, using the wireless connection and by the battery management system, a portion of the set of sensor data, wherein during transmitting, the vehicle management system is powered off.

20. The system of claim 15, wherein writing the set of sensor data to memory of the memory subsystem is performed using a first port, and wherein receiving, from the battery management system, the request to read the set of sensor data from the memory subsystem is performed using a second port that is different than the first port.
